(19) United States
(12) Patent Application Publication
(10) Pub. No.: US 2015/0067603 A1
(43) Pub. Date: Mar. 5, 2015

(54) DISPLAY CONTROL DEVICE

(71) Applicant: Kabushiki Kaisha Toshiba, Tokyo (JP)

(72) Inventor: Koto Tanaka, Kanagawa-ken (JP)

(73) Assignee: KABUSHIKI KAISHA TOSHIBA, Tokyo (JP)

(21) Appl. No.: 14/192,585

(22) Filed: Feb. 27, 2014

Related U.S. Application Data
(60) Provisional application No. 61/874,068, filed on Sep. 5, 2013.

(51) Int. Cl. G06F 3/0481; G06F 3/0484; G06F 3/0488; G06F 3/0482

(52) U.S. Cl. CPC G06F 3/04817; G06F 3/04815; G06F 3/0482; G06F 3/04842; G06F 3/0488
USPC 715/828

(57) ABSTRACT

According to one embodiment, a display control device includes a display, an object detector, and an arithmetic processor. The display receives information including a position and a pose of a solid body and displays the solid body that has a plurality of surfaces, at least two or more of the plurality of the surfaces each corresponding to an application. The object detector detects a gesture of a person to determine which one of a first gesture, a second gesture, and a third gesture. The first gesture is to change the position and pose of the solid body. The second gesture is to run the application. The third gesture is to initialize the position and pose of the solid body.

### CROSS-REFERENCE TO RELATED APPLICATIONS

This application is based upon and claims the benefit of priority from U.S. Provisional Application No. 61/874,068, filed on Sep. 5, 2013; the entire contents of which are incorporated herein by reference.

### FIELD

Embodiments described herein generally relate to a display control device.

### BACKGROUND

A known method is to display a solid body having icons on a display screen to make a user select one of the icons, which are used to give various instructions to information devices including computers with displays. The user shows several gestures, or touches the screen display to select an intended icon from the icons. An icon is a small picture or a symbol to depict content or an object to be processed.

Since an icon is provided on each of the sides of the solid body, a user performs the following operations:

a first operation to change a position of the solid body to see an intended icon of a plurality of icons;
a second operation to select the intended icon; and
a third operation to execute an application shown by the intended icon.

Using the solid body with icons in the background art, the user has difficulty in changing a position of the solid body freely. The user is normally required to repeat many operations to select the intended icon that is located on the back of the solid body.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 is a block diagram showing a display control device according to a first embodiment.

FIG. 2 is a diagram showing a solid body provided with icons according to the first embodiment.

FIG. 3 is a diagram showing a position and a pose of a solid body according to the first embodiment.

FIGS. 4A to 4C are diagrams showing first to third gestures according to the first embodiment.

FIG. 5 is a diagram showing operation modes of the display control device according to the first embodiment.

FIG. 6 is a diagram showing a change in the position and pose of the solid body due to the first gesture according to the first embodiment.

FIG. 7A is a diagram showing an operation to change the pose of the solid body according to the first embodiment.

FIG. 7B is a diagram showing the solid body having a pose that has been changed, according to the first embodiment.

FIG. 8 is a flow chart showing a behavior of the display control device according to the first embodiment.

FIGS. 9 to 11 are diagrams showing another solid body according to the first embodiment.

FIG. 12 is a diagram showing another pose of the solid body according to the first embodiment.

FIG. 13 is a diagram showing a solid body provided with icons according to a second embodiment.

FIG. 14 is a diagram showing the solid body having a pose that has been changed, according to the second embodiment.

FIG. 15 is a diagram showing another solid body provided with icons according to the second embodiment.

FIG. 16A is a diagram showing an operation to change the pose of the solid body according to a third embodiment.

FIG. 16B is a diagram showing the solid body having a pose that has been changed, according to the third embodiment.

FIG. 17 is a diagram showing a three-dimensional grid where a plurality of solid bodies is stored according to a fourth embodiment.

FIGS. 18A and 18B are diagrams showing a real space and a virtual space according to the fourth embodiment.

FIG. 19 is a block diagram showing a function of the display control device according to the fourth embodiment.

FIG. 20 is a block diagram showing a sequence of the display control device according to the fourth embodiment.

FIG. 21 is a diagram showing state transitions of the display control device according to the fourth embodiment.

### DETAILED DESCRIPTION

According to one embodiment, a display control device includes a display, an object detector, and an arithmetic processor. The display receives information including a position and a pose of a solid body and displays the solid body. The solid body has a plurality of surfaces, at least two or more of the plurality of the surfaces each corresponding to an application. The object detector detects a gesture of a person to determine which one of a first gesture, a second gesture, and a third gesture. The first gesture is to change the position and pose of the solid body. The second gesture is to run the application. The third gesture is to initialize the position and pose of the solid body. The arithmetic processor delivers first information, second information, or third information to the display. The first information is to change the position and pose of the solid body according to the first gesture. The second information is to execute a specific application corresponding to a specific surface of the surfaces according to the second gesture. The third information is to initialize the position and pose of the solid body according to the third gesture.

An embodiment will be described below with reference to the drawings. Wherever possible, the same reference numerals will be used to denote the same or like portions throughout the drawings. The same description will not be repeated.

### First Embodiment

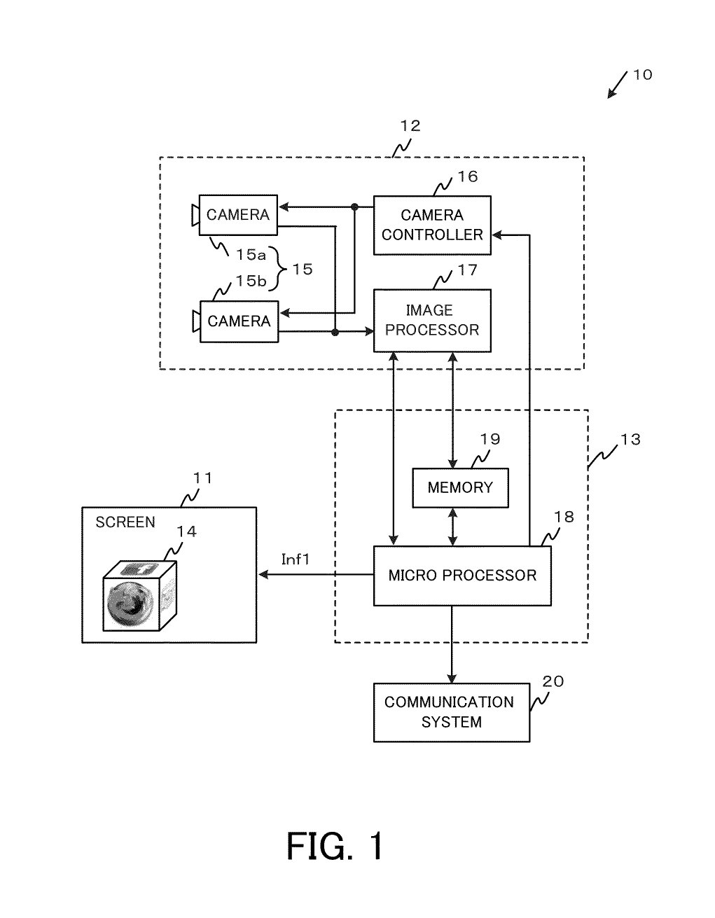

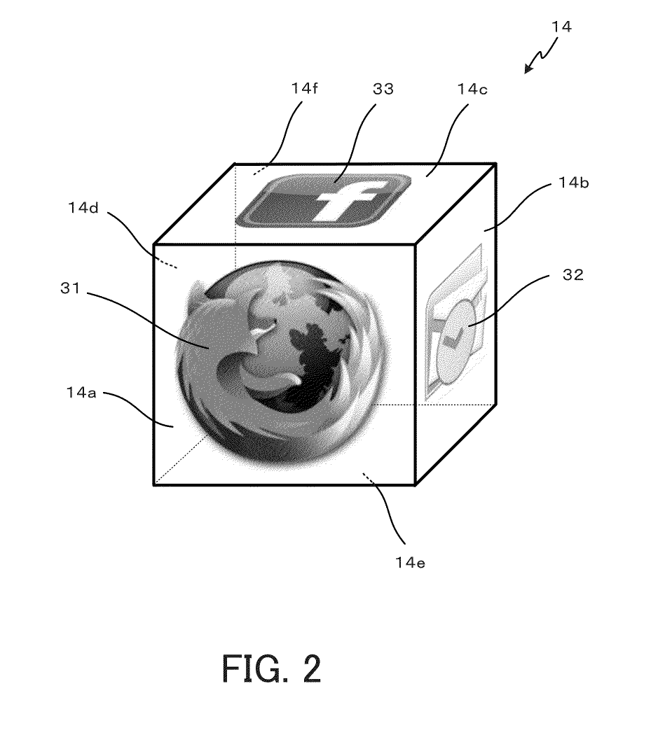

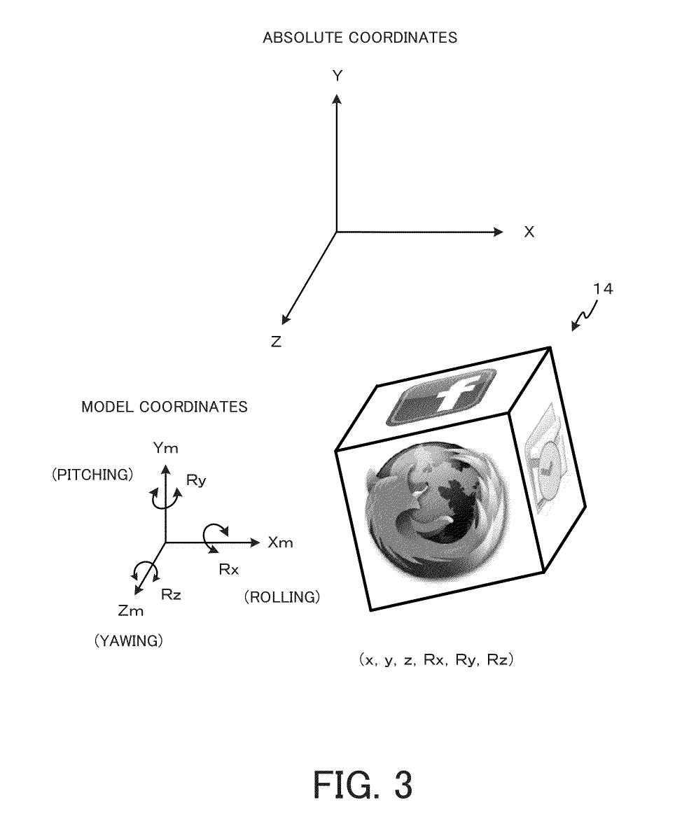

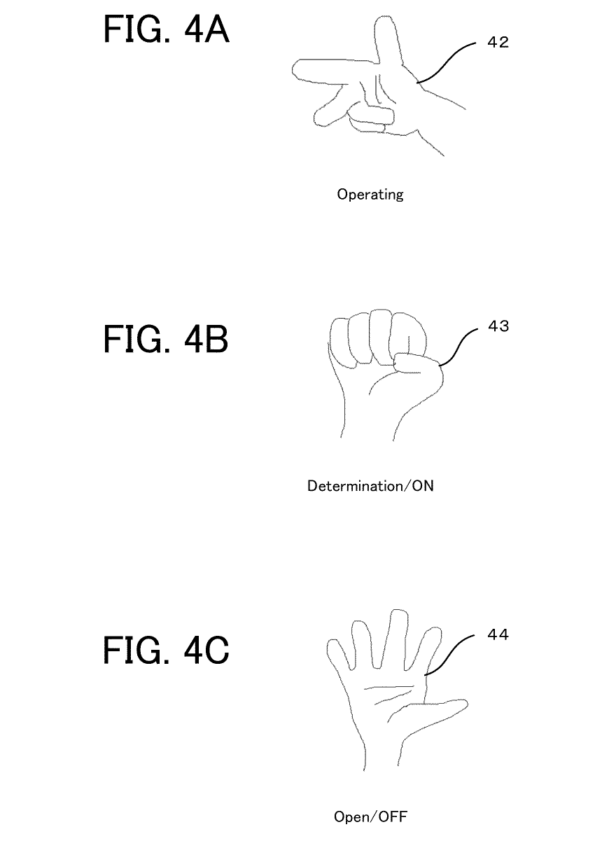

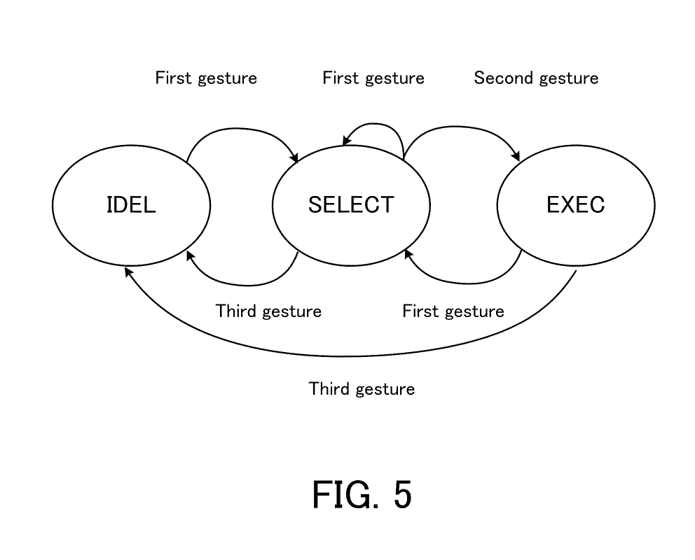

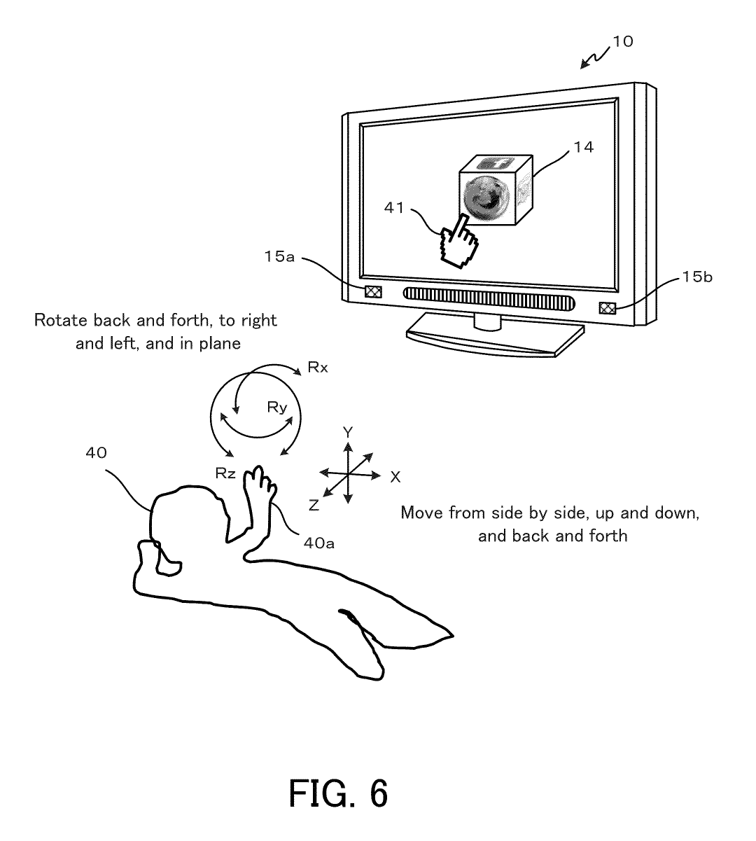

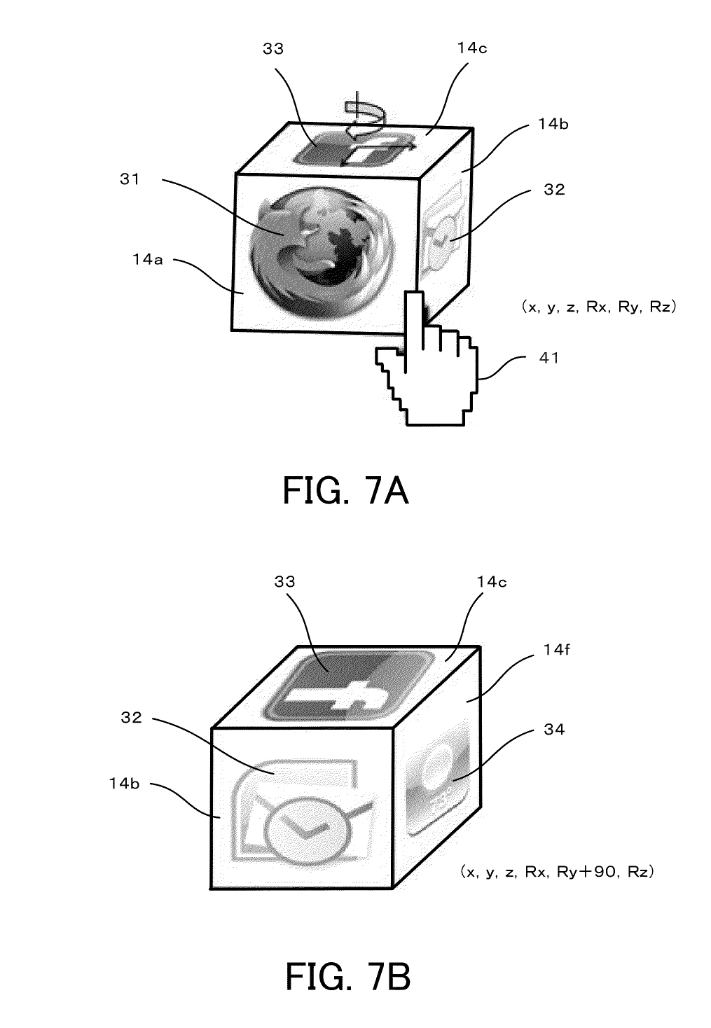

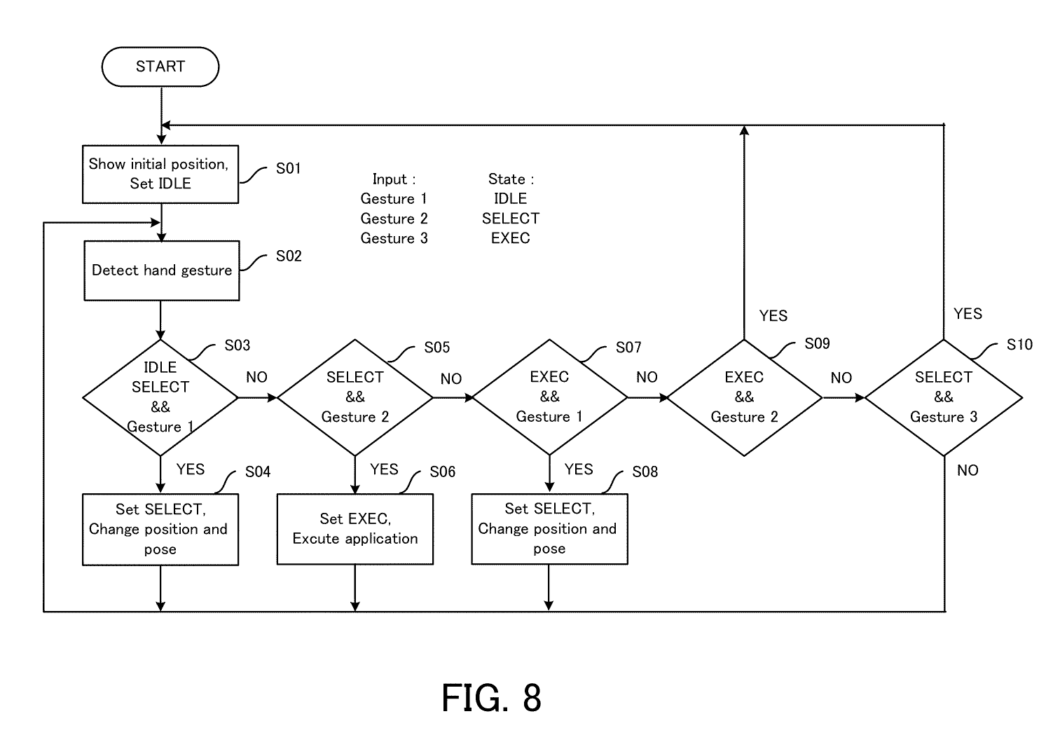

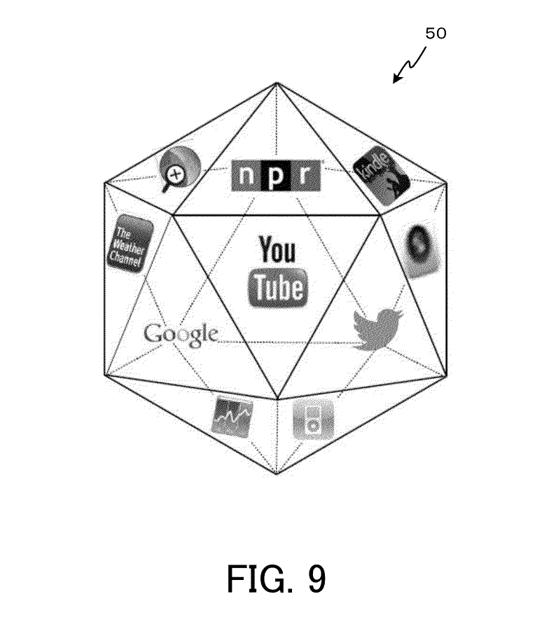

A display control device in accordance with a first embodiment will be described with reference to FIGS. 1 to 8. FIG. 1 is a block diagram showing a display control device. FIG. 2 is a diagram showing a solid body provided with icons. FIG. 3 is a diagram showing a position and a pose of the solid body. FIGS. 4A to 4C are diagrams showing first to third gestures. FIG. 5 is a diagram showing operation modes of a display control device. FIG. 6 is a diagram showing a change in the position and pose of the solid body due to the first gesture. FIG. 7A is a diagram showing an operation to change the pose of the solid body. FIG. 7B is a diagram showing the solid body having a pose that has been changed. FIG. 8 is a flow chart showing a behavior of the display control device.

As shown in FIG. 1, a display control device 10 includes a display 11 with a screen, an object detector 12, and an arithmetic processor 13.

The display 11 receives information Inf1 showing a position and a pose of a solid body 14 from the arithmetic processor 13 to three-dimensionally display the solid body 14 on the screen. The solid body 14 is assigned with a plurality of applications. The solid body 14 is a cube, for example. Hereinafter, the solid body 14 will be referred to as a cube 14.

The object detector 12 includes a stereo camera 15, a camera controller 16, and an image processor 17. The stereo camera 15 detects motion of a hand (object) of a person. The stereo camera 15 fundamentally includes two cameras 15a and 15b.

Two lenses are aligned at a regular interval in the stereo camera 15 to thereby reproduce binocular disparity due to subtly different angles of the lenses. Thus, the size of the hand of the person and a distance to the hand are sensed to determine the motion of the hand in a front-back direction toward the stereo camera 15.

The camera controller 16 receives commands from the arithmetic processor 13 to control the stereo camera 15. The camera controller 16 instructs the stereo camera 15 to set shooting conditions including shooting durations, and start and stop of shooting.

The image processor 17 receives image data from the stereo camera 15 to detect an object by pattern recognition. The image processor 17 analyses a motion of a human hand to determine first to third gestures.

The first gesture is to change a display position and a pose of the cube 14. The second gesture is to execute applications that correspond to the respective surfaces of the cube 14. The third gesture is to initialize a state of the cube 14. The image processor 17 notifies the arithmetic processor 13 of a determined result.

The arithmetic processor 13 has a microprocessor 18 and a memory 19. The microprocessor 18 executes processing in accordance with the determined result. The memory 19 stores various programs and various data, etc., which are necessary to operate the image processor 17 and the microprocessor 18. The memory 19 employs a nonvolatile semiconductor memory, for example.

When the first gesture is detected, the microprocessor 18 delivers the information Inf1 to the display 11 to change the position and pose of the cube 14 in accordance with the motion of the human hand.

When the second gesture is detected, the microprocessor 18 selects a surface having an apparently largest area among the surfaces of the cube 14 to deliver a command to a personal computer, etc., via a communication system. The command instructs a personal computer to execute an application corresponding to the selected surface.

When the third gesture is detected, the microprocessor 18 delivers information to the display 11 so as to return the position and pose of the cube 14 to an initial state of the cube 14. The microprocessor 18 delivers a command for stopping a running application to the personal computer, etc., through the communications system 20.

As shown in FIG. 2, the cube 14 has six surfaces 14a, 14b, 14c, 14d, 14e, and 14f. One application corresponds to each of the surfaces 14a to 14f of the cube 14. The surfaces 14a to 14f of the cube 14 each have an icon showing a corresponding application. Icons will express processing contents or objects in a small picture, a symbol or the like.

An application to connect a computer to the internet corresponds to the surface 14a, and is provided with an icon 31, for example. An application to perform an electronic mail and schedule control corresponds to the surface 14b, and is provided with an icon 32. An application to access a social network service (SNS) corresponds to the surface 14c, and is provided with an icon 33.

The cube 14 has up to three icons that can be simultaneously seen. The remaining three icons cannot be seen. Changing the pose of the cube 14 enables it to see the remaining three icons.

As shown in FIG. 3, the position of the cube 14 is expressed by a position vector (x, y, z) in absolute coordinates. The pose of the cube 14 is expressed by a rotation vector (Rx, Ry, Rz) around coordinate axes in model coordinates.

The absolute coordinates have an original point at a given point, an X-axis in a lateral direction in the screen, a Y-axis in a longitudinal direction in the screen, and a Z-axis in a direction vertical to the screen. The model coordinates have an original point at the center (not shown) of gravity of the cube 14. The model coordinates have an Xm-axis, a Ym-axis, and a Zm-axis, which are parallel to the X-axis, the Y-axis, and the Z-axis, respectively.

A position vector (x, y, z) is defined by a distance and a direction between the center of gravity of the cube 14 and the original point of the absolute coordinates. A rotation vector (Rx, Ry, Rz) is defined by rotation angles Rx, Ry, and Rz around the Xm-axis, the Ym-axis, and the Zm-axis, respectively. The rotation vector (Rx, Ry, Rz) corresponds to rolling, pitching, and yawing, respectively.

Determining six parameters (x, y, z, Rx, Ry, Rz) enables it to manipulate the position and pose of the cube 14. Present values of the position and pose of the cube 14 are assumed as (xi, yi, zi, Rxi, Ryi, Rzi), and variations in the position and pose of the cube 14 are assumed as (Δx, Δy, Δz, ΔRx, ΔRy, ΔRz).

Since the object detector 12 detects a three-dimensional motion of an object, the variations in the position and pose of the cube 14 are determined, e.g., in accordance with a difference of object image data acquired every sampling period.

Adding the variations in the position and pose of the cube 14 to the present values of the position and pose of the cube 14 enables the present values of the position and pose of the cube 14 to be updated. The updated present values of the position and pose of the cube 14 are expressed by (xᵢ=xᵢ₋₁+Δx, yᵢ=+yᵢ₋₁+Δy, zᵢ=zᵢ₋₁+Δz, Rxᵢ=Rxᵢ₋₁+ΔRx, Ryᵢ=Ryᵢ₋₁+ΔRy, Rzᵢ=Rzᵢ₋₁+ΔRz).

In a first motion, the arithmetic processor 13 computes variations in the position and pose of the cube 14, updates present values of the position and pose of the cube 14, and delivers the updated present values to the display 11.

In a third motion, the arithmetic processor 13 reads out initial values of the position and pose of the cube 14 from the memory 19 to deliver the initial values to the display 11.

The first to third gestures will be described below. FIG. 4A is a diagram showing a first gesture 42 that means an operating command. FIG. 4B is a diagram showing a second gesture 43 that means a Determination/ON command. FIG. 4C is a diagram showing a third gesture 44 that means an Open/OFF command.

As shown in FIG. 4A, the first gesture 42 is expressed by opening a thumb, a forefinger, and a middle finger such that the thumb, the forefinger, and the middle finger bisect each other at right angles. The first gesture 42 is the same as the pose showing a Fleming's right-hand rule.

As shown in FIG. 4B, a second gesture 43 is expressed by a fist. As shown in FIG. 4C, a third gesture 44 is expressed by opening a hand.

An operation mode of the display control device 10 will be described below. As shown in FIG. 5, the display control device 10 has three operation modes of IDLE, SELECT, and EXEC. In IDLE, the cube 14 is displayed in an initial state, and IDLE is waiting for the first gesture 42 of a user. In SELECT, the user can freely change the position and pose of the cube 14, and SELECT is waiting for the second and third gestures 43, 44 of the user. In EXEC, an application is in execution, and EXEC is waiting for the first and third gestures 42, 44 of the user.

When the first gesture 42 is detected at IDLE, the operation mode transits to SELECT. The operation mode transits from SELECT to EXEC and IDLE when the second and third gestures 43 and 44 are detected, respectively. The operation mode transits from EXEC to IDLE and SELECT when the third and first gestures 44, 42 are detected, respectively.

In SELECT, an operation command enables a user to freely change the position and pose of the cube 14 as many times as the user wants and to thereby execute a Determination/ON command and an Open/OFF command. The Determination/ON command causes an application to be executed. The application corresponds to an icon assigned to a surface with the largest apparent area among the surfaces of the cube 14. The Open/OFF command causes the position and pose of the cube 14 to be initialized.

In EXEC, the Open/OFF command causes the application in execution to be stopped and subsequently the position and pose of the cube 14 to be initialized.

Changing the position and pose of the cube 14 will be described below. In SELECT, the position and pose of the cube 14 will be changed by moving and rotating the first gesture 42.

As shown in FIG. 6, a lying person (object) 40 faces a screen that displays the cube 14. The person 40 raises a hand 40a of the person 40 and makes the first gesture 42 in order to manipulate the cube 14.

The object detector 12 detects the first gesture 42 to notify the arithmetic processor 13 of the first gesture 42 detected. The arithmetic processor 13 instructs the display 11 to display a maniform pointer 41 on the screen in order to show that the gesture 42 has been detected. The pointer 41 is in touch with the cube 14.

The person 40 moves and rotates the hand 40a by the first gesture 42. The person 40 is able to move the hand 40a from side to side, up and down, and back and forth, and also rotate the hand 40a back and forth, to right and left, and in a plane.

For example, motions to move the hand 40a from side to side, up and down, and back and forth are made to correspond to motions of the cube 14 in the X-direction, the Y-direction, and the Z-direction. Motions to rotate the hand 40a back and forth, to right and left, and in a plane are made to correspond to the rotations Rx, Ry, and Rz around the coordinate axes in the model coordinates.

When the hand 40a is waved leftward (rightward), the cube 14 moves in a −X-axis (+X-axis) direction on the screen. When the hand 40a is waved upward (downward), the cube 14 moves in a +Y-axis (−Y-axis) direction on the screen. When the hand 40a is waved forward (backward), the cube 14 moves in a +Z-axis (−Z-axis) direction on the screen.

When the hand 40a is rotated forward (backward), the cube 14 rotates in a +Rx (−Rx) direction on the screen. When the hand 40a is rotated leftward (rightward), the cube 14 rotates in a −Ry (+Ry) direction on the screen. When the hand 40a is rotated leftward (rightward) in a XY plane, the cube 14 rotates in a +Rz (−Rz) direction on the screen. A direction of a rotation vector is defined as being positive when the rotation is counterclockwise.

Moving or rotating the hand 40a by the first gesture 42 prevents the position and pose of the cube 14 from being changed unintentionally. Moving and rotating the hand 40a by any gestures other than the first gesture 42 are not capable of changing the position and pose of the cube 14.

FIG. 7A is a diagram showing the cube 14 before the cube 14 changes the pose thereof. FIG. 7B is a diagram showing the cube 14 after the cube 14 has changed the pose thereof. As shown in FIG. 7A, the pointer 41 is in touch with the cube 14. When the person 40 rotates the hand 40a counterclockwise around Ym-axis, the cube 14 rotates in a −Ry direction in response to the rotation of the hand 40a.

A rotation angle of the hand 40a does not necessarily correspond one-to-one to the rotation angle of the cube 14. When the rotation of the hand 40a is detected, the cube 14 may be controlled such that the cube 14 rotates by an angle of 90°.

As shown in FIG. 7B, the cube 14 rotates only by an angle of 90° clockwise, for example. As a result, the surface 14a disappears, and the surface 14f which has hidden appears. An application of a weather forecast is assigned to the surface 14f, for example, and an icon 34 is provided to the surface 14f. As shown in FIGS. 7A and 7B, the icon 33 provided to the surface 14c has already changed the direction of the icon 33 by 90°.

Parameters of the cube 14 are expressed as (x, y, z, Rx, Ry+90, Rz) subsequent to the change in the pose of the cube 14, provided that the parameters of the cube 14 are expressed as (x, y, z, Rx, Ry, Rz) prior to the change in the pose of the cube 14. Only Ry has changed.

The person 40 moves the hand 40a by the first gesture 42 to control the pose of the cube 14 such that an icon corresponding to an application that the person 40 wants to execute faces the person 40. A surface provided with the icon facing the person 40 has a largest apparent area among the surfaces of the cube 14.

Operation of the display control device 10 mentioned above will be described with reference to a flow chart. As shown in FIG. 8, the cube 14 provided with icons is shown in an initial state on the screen, and the operation mode of the cube 14 is set to IDLE.

Once a hand gesture of the person 40 is detected (Step S02), what the gesture is and the operation mode for the gesture are determined (Steps S03, S05, S07, S09, S10), processing is performed (Steps S04, S06, S08) in response to what the gesture is and the operation mode, and the processing ends to return to Step 02.

When the operation mode is IDLE or SELECT and the gesture corresponds to the first gesture 42 (YES at Step S03), the operation mode transits from IDLE to SELECT or maintains SELECT to change the position and pose of the cube 14 (Step S04).

When the operation mode is SELECT and the gesture corresponds to the second gesture 43 (YES at Step S05); the operation mode transits from SELECT to EXEC to execute an application (Step S06).

When the operation mode is EXEC and the gesture corresponds to the first gesture 42 (YES at Step S07); the operation mode transits from EXEC to SELECT to change the position and pose of the cube 14 (Step S08).

When the operation mode is EXEC and the gesture corresponds to the second gesture 43 (YES at Step S09); the operation mode returns to Step S01. When the operation mode is in SELECT and the gesture corresponds to the third gesture 44 (YES at Step S10); the operation mode goes to Step S01.

The first to third gestures 42, 43, 44 enable it to execute an application by intuitively selecting an intended icon from a plurality of icons through less movement.

As described above, the display control device 10 of the embodiment displays the cube 14 on the screen thereof. The cube 14 has a plurality of surfaces and at least two of the surfaces are assigned with icons corresponding to applications. The object detector 12 detects a shape of the hand 40a of the person 40 to determine one of the first to third gestures 42, 43, 44. The arithmetic processor 13 performs processing in accordance with the operation mode and the first to third gestures 42, 43, 44.

As a result, an intended icon out of a plurality of icons is intuitively selected through less movement, and an application corresponding to the intended icon is executed.

Although the solid body 14 has been described as a cube, the solid body 14 may be a polyhedron, each surface of which preferably has the same area. Alternatively, the solid body 14 may be a sphere.

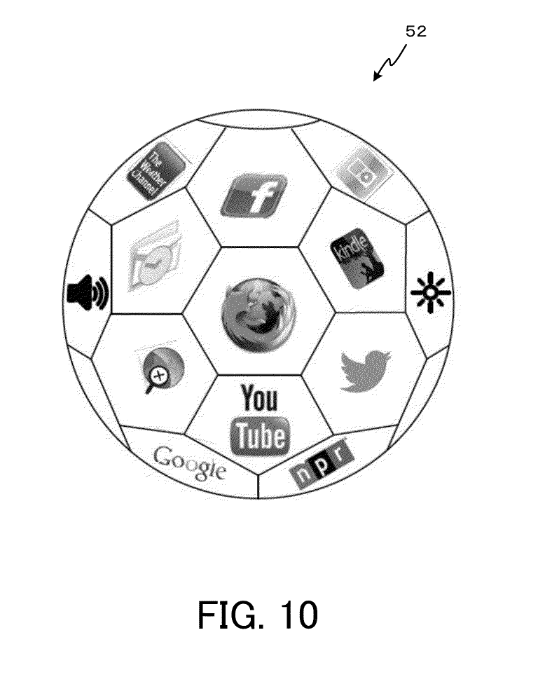

FIG. 9 is a diagram showing a solid body 50 that is an icosahedron. The solid body 50 consists of 20 regular triangles. Each of the triangles of the solid body 50 is provided with an icon.

FIG. 10 is a diagram showing a soccer-ball-shaped solid body 52. The solid body 52 consists of 12 regular pentagons and 20 regular hexagons. Five regular hexagons are arranged so as to surround one regular pentagon. Surfaces of the solid body 52 are each provided with an icon.

It could be difficult to intuitively select which surface is apparently the largest, because the regular hexagon and regular pentagon have areas different from each other. It is appropriate to make an icon, which is provided to a centrally visible surface, responsive to an executed icon.

FIG. 11 is a diagram showing a spherical solid body 54. The spherical solid body 54 has a plurality of spherical surfaces 54a each having the same area. The spherical surfaces 54a are each provided with one icon.

All the surfaces of the solid bodies 50, 52, 54 shown in FIGS. 9 to 11 are not necessarily provided with one icon. Just a required number of icons should be provided.

As described above, when the operation mode is in SELECT and the second gesture 43 indicating a Determination/ON command is detected, an application is executed corresponding to an icon provided onto a largest apparent surface among the surfaces of the solid body. However, depending on the pose of the solid body, a plurality of largest apparent surfaces could be present in some cases.

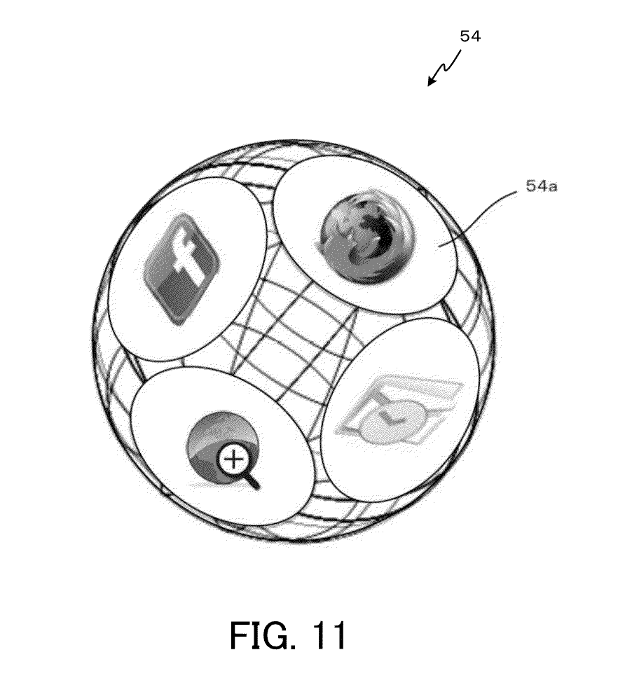

FIG. 12 is a diagram showing a pose of the solid body 14 where a plurality of largest apparent surfaces are present on the solid body 14. As shown in FIG. 12, when the person 40 looks straight at a straight line passing through the center of gravity (not shown) of the solid body 14 and a corner 14g (an intersection of three adjacent surfaces 14a, 14b, 14c) of the solid body 14; the three adjacent surfaces 14a, 14b, 14c seem to have the same size.

The plurality of the largest apparent surfaces prevents one icon from being selected, so that no application is executed. Alternatively, whenever the person 40 selects one of the icons on the adjacent surfaces 14a, 14b, 14c; an application corresponding to the icon selected by the person 40 may be executed.

As described above, only one solid body is displayed on the screen, but the number of solid bodies displayed on the screen is not particularly limited. Alternatively, a plurality of solid bodies may be displayed on the screen.

As described above, the hand 40a of the person 40 is detected with the stereo camera 15. Alternatively, the hand 40a may be detected by combining a camera and a distance meter. Distance meters include an ultrasonic distance meter, a laser distance meter, and a microwave distance meter. Alternatively, a three-dimensional depth sensor described later may be used.

Although changing the position and pose of the solid body has been described above, the size or color of the solid body may be changed. For example, the solid body is displayed in a small size and paled out initially. Once a movement of the solid body is detected, the solid body is displayed in a large size and in bright colors. Thus, visibility and operability of the solid body are enhanced on the screen.

### Second Embodiment

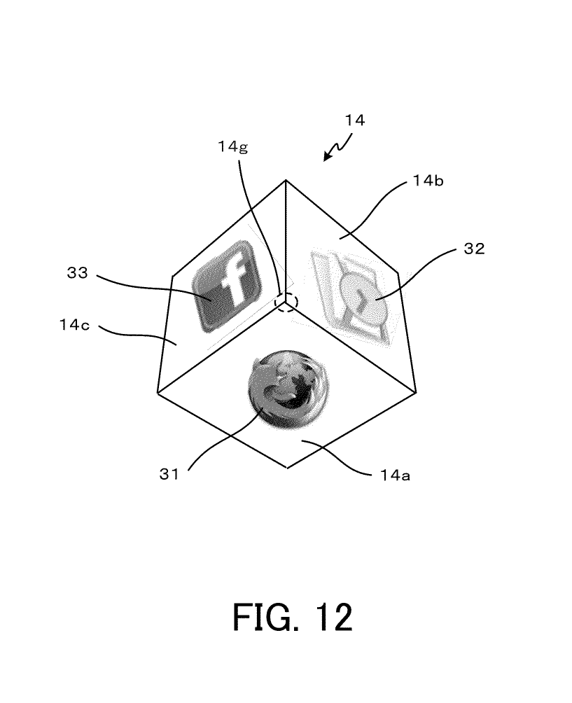

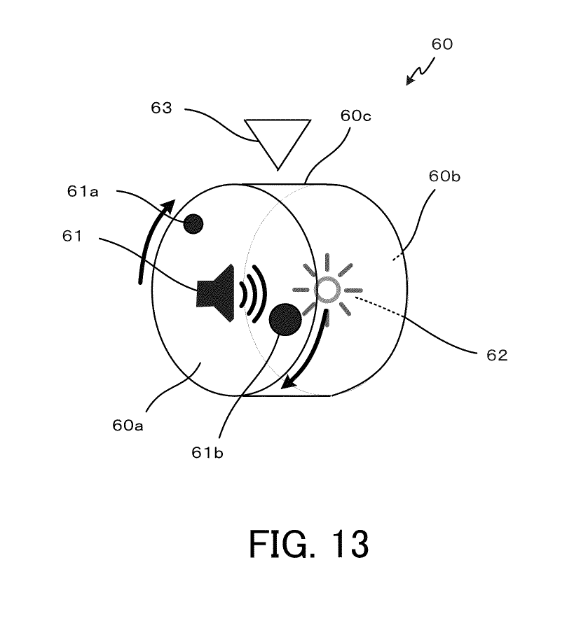

A display control device in accordance with a second embodiment will be described with reference to FIGS. 13 and 14. FIG. 13 is a diagram showing a solid body provided with an icon. FIG. 14 is a diagram showing the solid body in which the pose of the solid body has been changed.

Wherever possible, the same reference numerals will be used to denote the same or like portions throughout the drawings in the second embodiment. The same description will not be repeated in the detailed description. The second embodiment differs from the first embodiment in that the solid body is translucently displayed.

As shown in FIG. 13, a solid body 60 of the embodiment is disk-shaped. The solid body 60 will be referred to as a coin 60. The coin 60 has a first surface 60a and a second surface 60b, both being parallel to each other, and a side surface 60c. The coin 60 is displayed on the screen such that the coin 60 is in a position and a pose, both the position and the pose showing the first surface 60a and a portion of the side surface 60c, hiding the second surface 60b.

Displaying the coin 60 translucently enables it to see the second surface 60b, which should be hidden, through the first surface 60a and the side surface 60c.

The first surface 60a is provided with an icon 61. The second surface 60b is provided with an icon 62. The side surface 60c is provided with no icon. The icon 62 provided on the second surface 60b is seen through the first surface 60a and the side surface 60c. The front icon 61 is displayed deeply and the icon 62 on the back surface is displayed thinly.

The icon 61 corresponds to, e.g., an application that controls sound volume. The icon 62 corresponds to, e.g., an application that controls brightness of the screen.

FIG. 13 shows that the front icon 61 is under being selected. The sound volume is controlled by turning the coin 60 around the Zm-axis. Black dots 61a, 61b show turning directions to turn up and turn down the sound volume respectively. A triangle 63 appears above the coin 60, and does not move when the coin 60 rotates around the Zm-axis. A position of the triangle 63 shows to what extent the coin has been turned to control the sound volume.

When the coin 60 receives an instruction to rotate around the Zm-axis to thereby exceed the range from the black dot 61a to the black dot 61b, the instruction is made to be invalid and the coin rotates no more. The rotatable range of the coin is defined as the range from a point where the triangle 63a meets the black dot 61 to another point where the triangle 63 meets the black dot 61b.

When the gesture 43 corresponding to the Determination/ON command is detected, the application for adjusting the sound volume is executed so that the sound volume is adjusted by the point of the coin 60 denoted by the triangle 63. When the application requires an input of a sound volume, the coin 60 is rotated to input the sound volume in the same way as an analog device.

As shown in FIG. 14, an application for adjusting brightness is executed by inverting the two sides of the coin 60. The surface 60b that was the rear side of the coin 60 becomes a new front side to be provided with an icon 61, and the surface 60a that was the front side of the coin 60 becomes a new rear side of the coin 60. The icon 62 on the front side is deeply displayed and the icon 61 on the rear side is thinly displayed.

The position and pose of the coin 60 are expressed by a position vector (x, y, z) in an absolute coordinate, and a rotation vector (Rx, Ry, Rz) around a model-coordinate axis as well as in FIG. 3. The position and pose of the coin 60 are changed in accordance with a motion of the first gesture 42 as well as in FIG. 6.

Once the gesture 43 corresponding to a Determination/ON command is detected, an application for adjusting brightness is executed to set the brightness specified by the triangle 63.

As described above, since the coin 60 is displayed translucently, the icon 62 on the second surface 60b that is normally invisible can be seen through the first surface 60a and the side surface 60c. It is therefore easy to look for a desired icon.

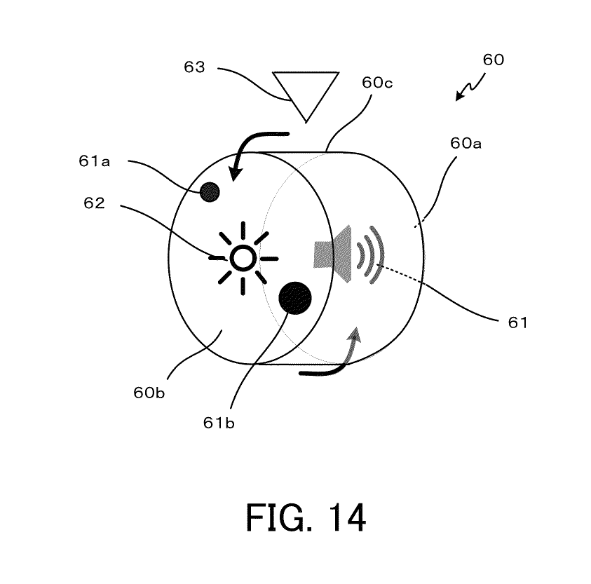

As described above, the solid body is translucently displayed with a coin, but the shape of the solid body is not limited in particular. FIG. 15 is a diagram showing a solid body of triangular pyramid, the triangular pyramid having four regular triangles of equal size.

As shown in FIG. 15, the triangular pyramid 70 has the three sides 70a, 70b, 70c, and a bottom 70d. The triangular pyramid 70 is displayed on the screen as follows. The two sides 70a, 70b can be seen while the side 70c and the bottom 70d cannot be seen on the screen.

Since the triangular pyramid 70 is displayed translucently, the side 70c and the bottom 70d can be seen through the two sides 70a, 70b. An icon 33 is provided onto the side 70a, for example. An icon 31 is provided onto the side 70b, for example. An icon 34 is provided onto the side 70c, for example. An icon 32 is provided onto the bottom 70d, for example.

The icons 34 and 32 provided on the side 70c and the bottom 70d, respectively, can be seen through the sides 70a and 70b. It is therefore easy to look for a desired icon.

As shown in FIG. 4B, once the gesture corresponding to a Determination/ON command is detected, an application corresponding to the icon 31 provided onto the surface 70b with a largest apparent area is executed.

Alternatively, the solid bodies 14, 50, 52, 54, which are shown in FIGS. 2, 9, 11, may be displayed translucently. The icons on the rear side could be hidden to be invisible by the icon on the front side in the solid bodies 50, 52, and 54, all of which have a plurality of surfaces. Providing icons dispersively on some of the surfaces are better than providing one icon on every surface in the solid bodies 50, 52, 54, all of which have a plurality of surfaces.

### Third Embodiment

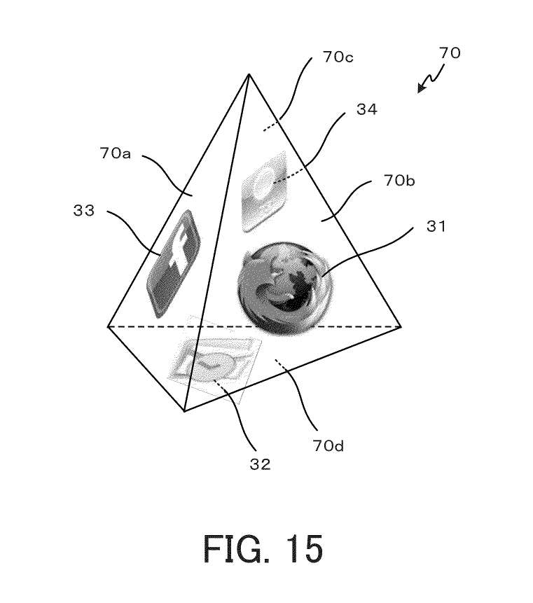

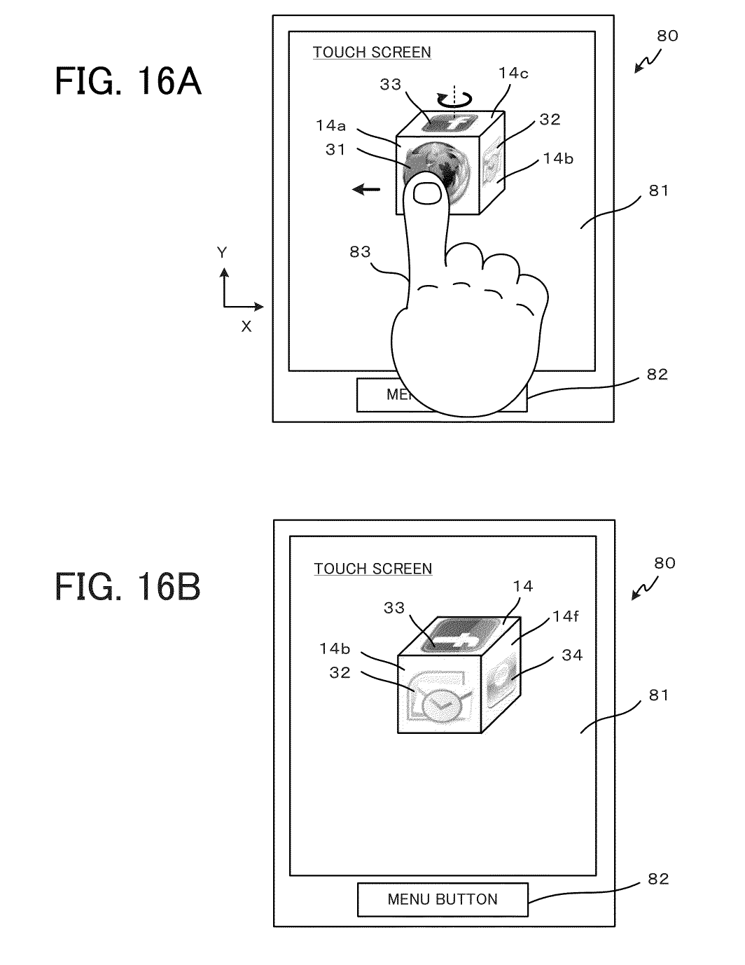

A display control device in accordance with a third embodiment will be described with reference to FIGS. 16A and 16B. FIG. 16A is a diagram showing operation of changing a pose of a solid body. FIG. 16B is a diagram showing a solid body which has a changed pose.

Wherever possible, the same reference numerals will be used to denote the same or like portions throughout the drawings in the third embodiment. The third embodiment differs from the first embodiment in that the third embodiment includes a touch screen.

As shown in FIGS. 16A and 16B, the display control device 80 of the embodiment is built into apparatuses, which includes a mobile phone terminal and a tablet terminal. A display of the display control device 80 includes a touch screen 81. A menu button 82 is provided below the display.

The cube 14 is displayed on the touch screen 81. The position and pose of the cube 14 will be changed by a first motion as follows. Slow movement of a finger changes a position vector (x, y, z), and fast movement of the finger changes a rotation vector (Rx, Ry, Rz).

The finger in touch with the touch screen 81 is moved in any one direction of the X-direction, the Y-direction, and a diagonal direction with respect to the X-direction and the Y-direction at a first velocity. When the finger is moved in the X-direction, a position vector (x) is changed. When the finger is moved in the Y-direction, a position vector (y) is changed. When the finger is moved in the diagonal direction, a position vector (z) is changed.

A finger is moved in any one direction of the X-direction, the Y-direction, and the diagonal direction at a second speed higher than the first speed. Moving the finger in the X-direction changes the rotation vector (Rx). Moving the finger in the Y-direction changes the rotation vector (Ry). Moving the finger in the diagonal direction changes the rotation vector (Rz).

As shown in FIG. 16A, when a finger 83 gets in touch with the cube 14 displayed on the touch screen 81 and moves in the X-direction quickly (at the second velocity); the cube 14 rotates in the −Ry-direction on the touch screen 81. The moving distance of the finger 83 does not necessarily correspond one-to-one to the rotation angle of the cube 14. Whenever a quick movement of the finger 83 is detected, the cube 14 may rotate by 90° in response to the quick movement.

As shown in FIG. 16B, the cube 14 clockwise rotates only by 90°, for example. The side 14a that has been visible becomes invisible, and the side 14f that has been invisible becomes visible.

Double-clicking or double-tapping the touch screen 81A performs a second motion to execute applications corresponding to the icons provided to the cube 14. An application is executed, which corresponds to the icon provided on a side with an apparently largest area among a plurality of sides.

Pursing fingers in touch with the touch screen 81 performs a third motion to return the cube 14 to an initial state thereof.

As described above, the display control device 80 of the embodiment has the touch screen 81. A specific motion of the fingers on the touch screen 81 is detected to determine to which motion of first to third motions the specific motion corresponds. The display control device 80 of the embodiment is suitable for devices including mobile communication terminals, tablet devices, head-mounted displays, and notebook computers.

Although the first to third motions have been described as being performed only by motions of fingers, a menu button 82, the touch screen 81, and a screen keyboard on the touch screen 81 may be used together with the first to third motions. A keyboard and a mouse are used for a notebook computer.

### Fourth Embodiment

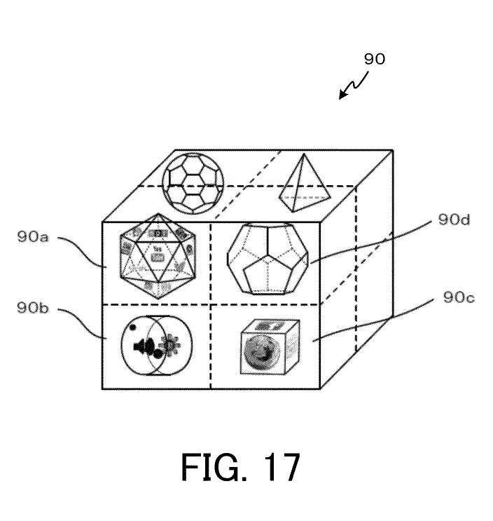

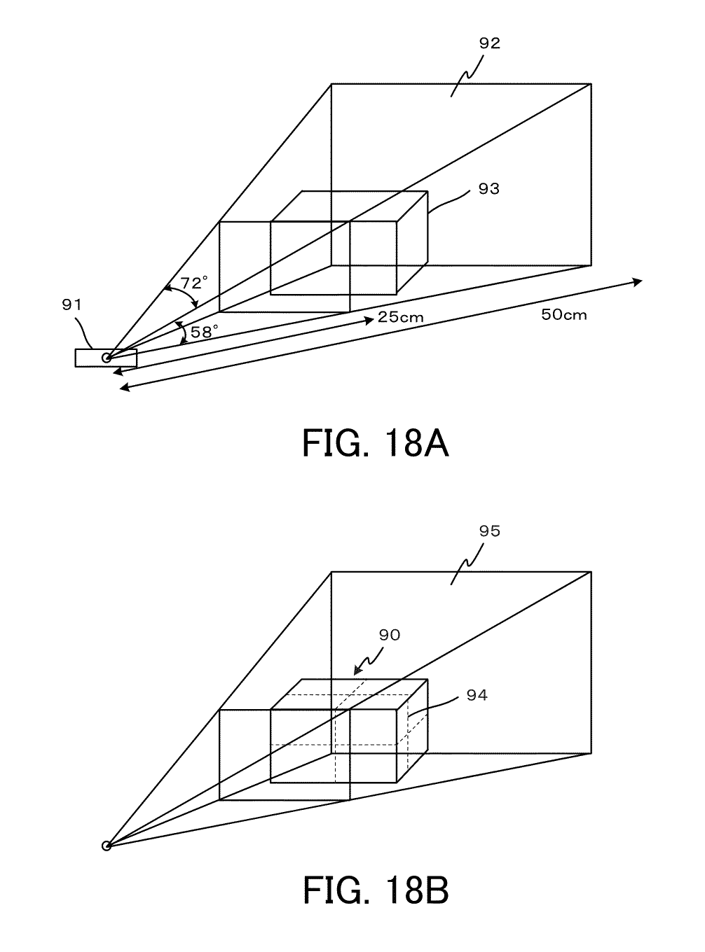

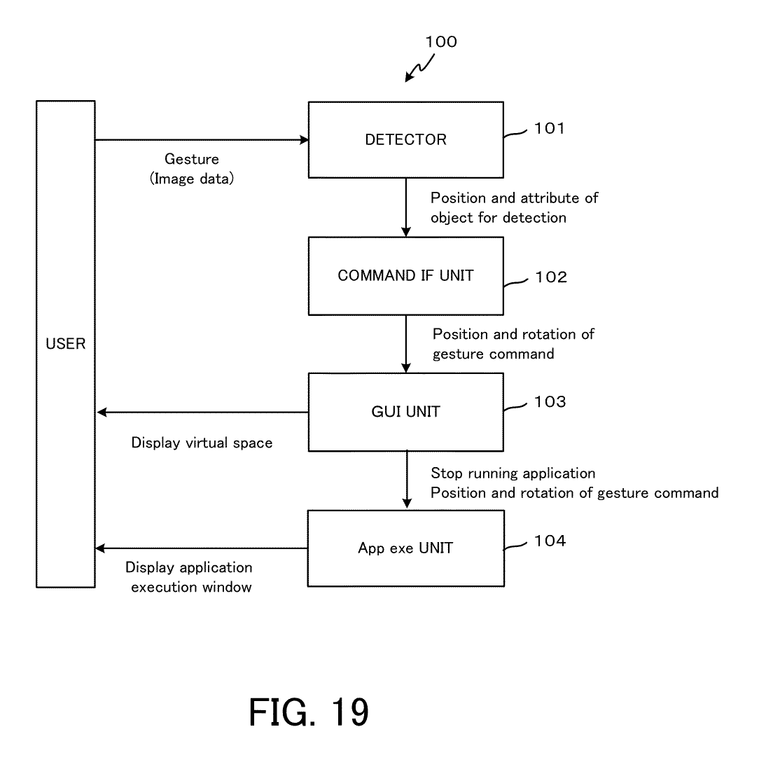

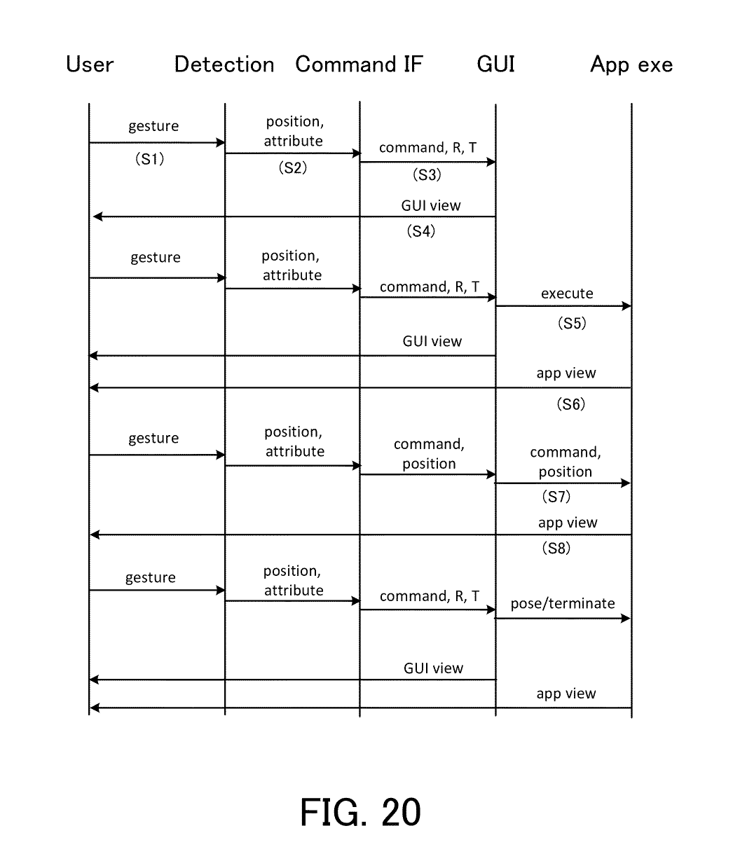

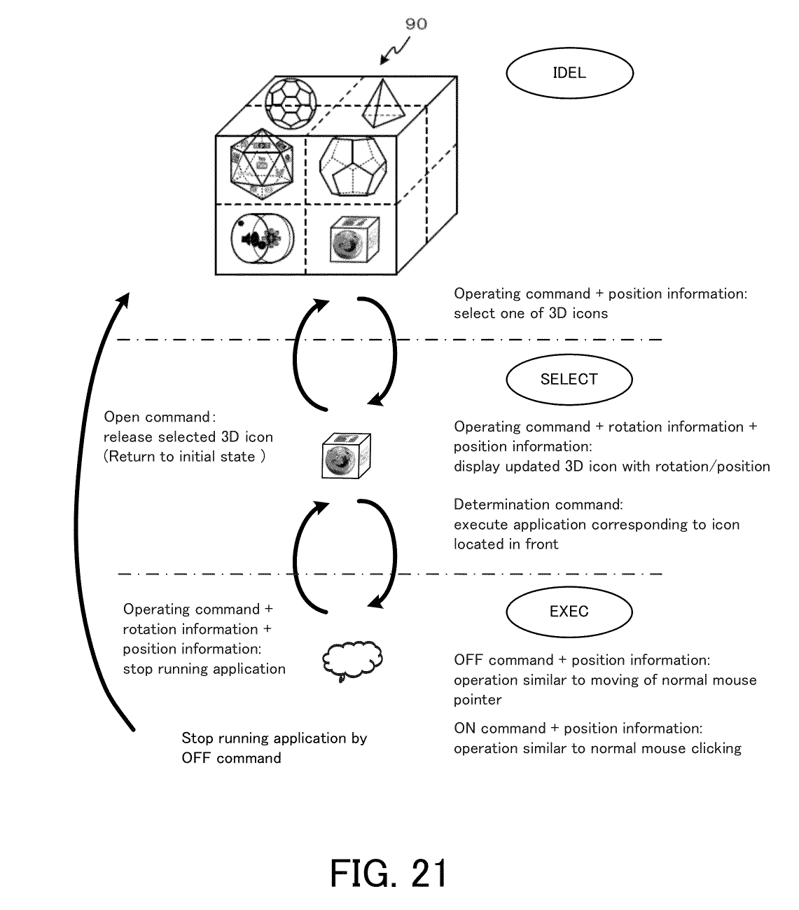

A display control device in accordance with a fourth embodiment will be described with reference to FIGS. 17 to 21. FIG. 17 is a diagram showing a three-dimensional grid where a plurality of solid bodies is stored. FIGS. 18A and 18B are diagrams showing real space and virtual space. FIG. 19 is a block diagram showing a function of the display control device. FIG. 20 is a diagram showing sequence of the display control device. FIG. 21 is a diagram showing a transition state of the display control device.

Wherever possible, the same reference numerals will be used to denote the same or like portions throughout the drawings in the fourth embodiment. The same description will not be repeated in the detailed description. The fourth embodiment differs from the first embodiment in that a plurality of solid bodies has been stored in a three-dimensional grid.

As shown in FIG. 17, a three-dimensional grid 90 is displayed on the screen of the display control device of the embodiment. The solid bodies are displayed at a position and a pose on the screen such that each of the solid bodies is stored at the position, which is preliminarily designated in the grid.

The three-dimensional grid 90 is has 2×2×2 cells, for example. The three-dimensional grid 90 can store up to eight solid bodies. The solid bodies in the grid 90 are preferably polyhedrons different from each other. For example, a regular icosahedron is stored in a cell 90a. The coin 60 is stored in a cell 90b. The cube 14 is stored in a cell 90c. A regular dodecahedron is stored in a cell 90d.

Storing a plurality of solid bodies in the three-dimensional grid 90 enables it to compactly display a plurality of solid bodies.

The three-dimensional grid 90 is defined to detect a motion of an object using a three-dimensional depth sensor. The three-dimensional depth sensor irradiates the object with an infrared dot pattern to determine a three-dimensional position and an irregularity of the object in accordance with a spatial difference between the dot pattern reflected from the object and the dot pattern reflected from a background.

Specifically, the three-dimensional depth sensor has an ordinary visible light camera, an infrared projector, and an infrared camera. The infrared projector and the infrared camera are arranged on the both sides of the visible light camera.

The infrared projector irradiates an object with the infrared dot pattern. An infrared camera takes a picture of the infrared dot pattern reflected from the object, and the infrared dot pattern reflected from the background of the object, e.g., walls.

Since the infrared projector and the infrared camera are horizontally located away from each other, the infrared camera can see a shadow of the object. The infrared dot pattern is widely-spaced in an area where the shadow of the object is made, and is narrowly-spaced on the opposite side of the area. It should be noted that the larger a distance difference between the widely-spaced dot pattern and the narrowly-spaced dot pattern, the nearer the object is.

As shown in FIG. 18A, a real space 92, which enables the three-dimensional depth sensor 91 to be operable, has an angular field that is horizontally 72° and vertically 58°, and an effective distance of 25 cm to 50 cm. A cube 93 is defined in the real space 92 in advance.

As shown in FIG. 18B, the three-dimensional grid 90 is made up of line segments forming the cube 93 defined in the real space 92 and additional line segments 94 in a virtual space 95. The additional line segments 94 divide the cube 93 into predetermined cells of the three-dimensional grid 90.

Operation of the display control device of the embodiment will be described from a functional viewpoint. As shown in FIG. 19, a system 100 includes a detector 101, a command interface (referred to as command IF) unit 102, a GUI (Graphical User Interface) unit 103, and App-exe (Application execute) unit 104.

A user can see a detected finger or hand as a pointer in the virtual space 95. When a solid body in a cell pointed by the user is selected by a gesture of the user, a position and a pose of the solid body is changed by the gesture of the user.

An OFF gesture 44 of the user returns the selected solid body to the original position in the cell. A determination gesture 43 of the user causes GUI to run an application corresponding to an icon having an apparently largest area.

FIG. 20 is a diagram showing a sequence of this scenario. A principal portion of this scenario will be described. As shown in FIG. 20, the detector 101 receives image data of a user's gesture (S1) to output a detected position and an attribute of the user, which relates to a finger or a hand (S2). The command IF unit 102 receives the detected position and attribute of the user to output an analyzed gesture command and a position and a rotation of the gesture command (S3). The GUI unit 103 receives the position and rotation of the gesture command to display what to display as GUI (S4).

The GUI unit 103 delivers an output to prompt the execution or stop of an application selected by inputting the position and rotation of the gesture command (S5). The App-exe unit 104 receives the output to execute or stop the application selected and to subsequently notify the user of the output showing the execution or stop of the application (S6).

The GUI unit 103 outputs the position of the gesture command by the position and rotation of the gesture command (S7). The App-exe unit 104 operates the application by the inputting of the command and position from the GUI unit 103 to notify the user of an operation result (S8).

As shown in FIG. 21, GUI is in IDLE as an initial state. Each definition of cells included in the three-dimensional grid 90 is given to the three-dimensional grid 90 from a file, and a solid body is given a definition of the position and pose of the solid body from the file so that GUI displays the solid body on the screen.

When “Operation Command” (the first gesture 42) and “position information of a hand in the three-dimensional grid 90” are detected at IDLE, the operation mode transits to SELECT.

When “Operation Command,” “Rotation Information” (Δ Rx, Δ Ry, Δ Rz), and “Position Information” (Δ x, Δ y, Δ z) are detected at SELECT, the position and pose of the solid body are updated. GUI displays the updated position and updated pose of the solid body.

When “Release Command” (the third gesture 44) is detected at this time, the pose of the solid body is updated, the position of the solid body is returned to IDLE, and the operation mode transits to IDLE.

When “Determination Command” (the second gesture 43) is detected at SELECT, the application corresponding to an icon having an apparently largest area is executed, the operation mode transits to EXEC.

When “Determination Command” (the second gesture 43) is detected at EXEC, not only GUI of the demonstration application but GUI of the executed application may be operable. When the application receives “OFF-command” (third gesture 44) and position information, the application acquires operation similar to the moving of a normal mouse pointer. When the application receives “ON-command” (third gesture 44) and the position information, the application acquires operation similar to normal mouse clicking (like clicking of the right mouse button).

When “Determination Command”, “Rotation Information”, and “Position Information” are detected at EXEC, the solid body that has been lastly selected is updated regarding “Rotation Information” and “Position Information”, GUI updates the display of the solid body, the operation mode transits to SELECT.

When the “application ending due to ON-Command” is detected at SELECT, the operation mode transits to IDLE. The ON-Command selects and determines an “x” button displayed on the upper portion of the window of the application. The application may be ended by OFF-command (gesture 44).

Detailed functional requirements in IDLE will be described below. The three-dimensional grid 90 gives notice to the solid body inside the grid 90 when a position in the virtual space 95 is located inside the three-dimensional grid 90 in the virtual space 95. The solid body receives the notice to raise the brightness of a displayed picture or to brighten the outline of the displayed picture. The three-dimensional grid 90 raises the transparency of solid bodies at the front side of the three-dimensional grid 90 when the pointer corresponding to inputted positional information is located at the rear side of the three-dimensional grid 90. That is, an icon provided to a solid body located at a rear portion of the three-dimensional grid 90 is easy to be seen.

GUI displays a position corresponding to the inputted positional information as a pointer in the virtual space 95. When an OFF-pose (gesture 44) is detected, GUI displays a palm center of the hand and the respective fingers of the hand by different colors.

Detailed functional requirements in SELECT will be described. The three-dimensional grid 90 displays positions of the respective fingers in the operation command (gesture 42). When a unique surface having a largest apparent area is not identified, applications corresponding to the icons on the largest apparent areas are not executed.

As described above, a plurality of solid bodies are preliminarily stored in the three-dimensional grid 90 and displayed in this embodiment. Just a solid body provided with a desired icon is taken out of the three-dimensional grid 90 to thereby perform necessary operations. A plurality of solid bodies is compactly displayed to enable it to execute a target application by a small number of operations.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display control device, comprising:
a display which receives information including a position and a pose of a solid body and displays the solid body, the solid body having a plurality of surfaces, at least two or more of the plurality of the surfaces each corresponding to an application;
an object detector which detects a gesture of a person to determine which one of a first gesture, a second gesture, and a third gesture, the first gesture to change the position and pose of the solid body, the second gesture to run the application, the third gesture to initialize the position and pose of the solid body; and
an arithmetic processor which delivers first information, second information, or third information to the display, the first information to change the position and pose of the solid body according to the first gesture, the second information to execute a specific application corresponding to a specific surface of the surfaces according to the second gesture, the third information to initialize the position and pose of the solid body according to the third gesture.

2. The device according to claim 1, wherein
the position of the solid body is expressed by a position vector (x, y, z) in absolute coordinates, and the pose of the solid body is expressed by a rotation vector (Rx, Ry, Rz) around coordinate axes in model coordinates.

3. The device according to claim 1, wherein
an icon is provided to the at least two or more of the plurality of the surfaces each corresponding to the application.

4. The device according to claim 3, wherein
the solid body is translucently displayed, so that an icon provided to a rear surface of the solid body can be seen through the solid body.

5. The device according to claim 1, wherein
the solid body is a polyhedron or a sphere.

6. The device according to claim 1, wherein
the display displays a plurality of solid bodies stored in a three-dimensional grid.

7. The device according to claim 1, wherein
the first gesture includes a shape of a hand; a movement of the hand in an X-direction, a Y-direction, and a Z-direction in the absolute coordinates; and a rotation of the hand around an X-axis, a Y-axis, and a Z-axis in model coordinates.

8. The device according to claim 1, wherein
the second gesture and the third gesture include a shape of a hand.

9. The device according to claim 1, wherein
the object detector includes a stereo camera or a three-dimensional depth sensor.

10. The device according to claim 1, wherein
information for stopping a running application is delivered at the third gesture.

11. A display control device, comprising:
a display which receives information including a position and a pose of a solid body and displays the solid body, the solid body having a plurality of surfaces, at least two or more of the plurality of the surfaces each corresponding to an application;
an object detector which detects a movement of an object to determine which of a first movement, a second movement, and a third movement, the first movement to change the position and pose of the solid body, the second movement to run the application, the third movement to initialize the position and pose of the solid body; and
an arithmetic processor which delivers first information, second information, or third information to the display, the first information to change the position and pose of the solid body according to the first movement, the second information to execute a specific application assigned to a specific surface of the surfaces according to the second movement, the third information to initialize the position and pose of the solid body according to the third movement.

12. The device according to claim 11, wherein
the position of the solid body is expressed by a position vector (x, y, z) in absolute coordinates, and the pose of the solid body is expressed by a rotation vector (Rx, Ry, Rz) around coordinate axes in model coordinates.

13. The device according to claim 11, wherein
an icon is provided to the at least two or more of the plurality of the surfaces each corresponding to the application.

14. The device according to claim 13, wherein
the solid body is translucently displayed, so that an icon provided to a rear surface of the solid body can be seen through the solid body.

15. The device according to claim 11, wherein
the solid body is a polyhedron or a sphere.

16. The device according to claim 11, wherein
the display displays a plurality of solid bodies stored in a three-dimensional grid.

17. The device according to claim 11, wherein
the object is a touch screen.

18. The device according to claim 17, wherein
the first movement includes a movement of the finger in any one direction of an X-direction, a Y-direction, and a diagonal direction with respect to the X-direction and the Y-direction at a first velocity, and a movement of the finger in any one direction of the X-direction, the Y-direction, and the diagonal direction at a second speed higher than the first speed.

19. The device according to claim 17, wherein
the second movement includes double-clicking or double-tapping the touch screen.

20. The device according to claim 17, wherein
information for stopping a running application is delivered at the third movement.
